(19) United States
(12) Patent Application Publication
(10) Pub. No.: US 2009/0166915 A1
(43) Pub. Date: Jul. 2, 2009

(54) Method and Device For Extruding Strip-Shaped Member

(75) Inventor: Yo Uchida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Tokyo (JP)

(21) Appl. No.: 12/097,391

(22) PCT Filed: Dec. 8, 2006
(86) PCT No.: PCT/JP2006/324578

§ 371 Date: Jul. 3, 2008

(30) Foreign Application Priority Data
Dec. 16, 2005 (JP) 2005-362736

(51) Int. Cl. B29C 47/10; B29C 45/58; B29C 45/60

(52) U.S. Cl. 264/176.1; 425/378.1

(57) ABSTRACT

The present invention easily increases an extrusion speed of strip-shaped member B from a gear pump extruder 21. Unvulcanized rubber K heated by a heater 17 is extruded temporarily as a strip-shaped body Z under the atmospheric pressure, and thereafter, is extruded from the gear pump extruder 21 as the strip-shaped member B, so that a temperature of the strip-shaped member B at the time of extrusion is lowered compared with that in a conventional technology. Here, even when the temperature of the strip-shaped member B is risen up to that in the conventional technology, any problem is not likely to occur, so that it is allowed to speed up, only by a degree corresponding to the above-mentioned difference between the temperatures, an operation speed of the respective heater 17, a pushing means 35, and the gear pump extruder 21, in other words, to rise the extrusion speed in the extruder 21.

### TECHNICAL FIELD

The present invention relates to a method and a device for extruding a strip-shaped member having a fixed amount or a member by means of a gear pump extruder.

### RELATED ART

As a conventional method and device for extruding a strip-shaped member, there is known, for example, a technology disclosed in Japanese Patent Application Laid-Open No. 2001-150515.

This device is provided with a screw heater for forwardly flowing rubber composition while heating the composition by rotating its screw, and a gear pump extruder directly connected to a front end of the heater for extruding the heated rubber composition fed from the heater without any change (directly) to form the strip-shaped member.

Such device adjusts a rotation speed of the screw of the heater as well as that of a gear of the gear pump and pushes the rubber composition into the extruder (gear pump) by means of the heater, and keeps the composition therebetween pressurized in order to prevent the air from mixing in the extruded strip-shaped member.

### DISCLOSURE OF THE INVENTION

However, when a gear pump extruder is directly connected to a front end of a screw heater as in the above-mentioned conventional method and device for extruding a strip-shaped member, a destination to which rubber composition is extruded from a heater is a highly-pressurized area between the heater and the extruder, so that in a flow passage between a screw and a barrel in the heater as well as between the heater and the extruder (gear pump), a flow of the rubber composition is arisen by a back flow, retention, or pressure-reducing, thereby generating excess heat, which results in a significantly high temperature of the composition when extruded from a die. Here, if the temperature of the rubber composition at the time of extrusion is equal to or more than the vuncanization-initiating temperature, premature crosslinking occurs to the rubber composition (strip-shaped member), so that the temperature of the composition is restricted to that slightly lower than t the vuncanization-initiating temperature. As a result, although high-speed extrusion has been recently required owing to a request of improvement in productivity, there exists an issue that the extrusion speed is limited to a value having the lower extrusion speed.

Especially when the rubber composition made up of high-viscosity rubber that tends to easily generate heat, or by contraries, rubber that generates less heat and thus has difficulty being evenly heated by means of the conventional extrusion method and device is extruded by means of a conventional extruding method and device, a screw length of the heater is lengthened in order to perform necessary heating. However, when the screw length of the heater is lengthened in this way, the temperature of the rubber composition easily rises, especially in the former high-viscosity rubber, the temperature of the composition promptly rises up to the vulcanization-initiating temperature or more, so that the rotation speed of the screw in the heater needs to be significantly decreased, and accordingly, the extrusion speed is limited to that having a further lowered value.

It is an object of the present invention to provide a method and a device for extruding a strip-shaped member, capable of easily increasing an extrusion speed of the strip-shaped member from an extruder.

This object can be firstly achieved by means of a method for extruding a strip-shaped member, comprising the steps of: heating unvulcanized rubber with a heater and extruding the rubber as a strip-shaped body; pulling the strip-shaped body extruded from the heater and passing through the air without any change into a pushing means to pushingly feed the body to a gear pump extruder as shapeless unvulcanized rubber; and extruding the fed unvulcanized rubber using the extruder to form a strip-shaped member.

The object can be secondary achieved by means of a device for extruding a strip-shaped member, comprising: a heater for heating unvulcanized rubber and extruding the rubber as a strip-shaped body; a gear pump extruder placed at a position spaced apart from the heater for extruding the fed unvulcanized rubber to form a strip-shaped member; and a pushing means placed adjacently at an upstream side of the extruder and pulling the strip-shaped body extruded from the extruder as well as having passed through the air without any change to push the body into the extruder as shapeless unvulcanized rubber.

In the present invention, the unvulcanized rubber heated by the heater is extruded, at first, as the strip-shaped body and passes through the air, and then, is guided into the pushing means without any change to become shapeless, and thereafter, the unvulcanized rubber extruded in the gear pump extruder by the pushing means as the strip-shaped member, so that the unvulcanized rubber is extruded from the heater at the atmosphere pressure, which is lower than the pressure in a conventional technology, to be formed as the strip-shaped body. As a result, the back flow, the retention, or the pressure-reducing like the above-mentioned are not likely to occur in the unvulcanized rubber in the heater, thereby significantly lowering a temperature of the strip-shaped body extruded from the heater. Further, in this state, the strip-shaped body (unvulcanized rubber) is guided into the extruder through the pushing means, so that the temperature of the strip-shaped member (unvulcanized rubber) at the time of extrusion is also lowered more than that in the conventional technology.

Here, enhancing an extrusion speed in the extruder leads to an increase in the flow, friction resistance and the like, and accordingly, results in a rise in the temperature of the strip-shaped member. However, even when the temperature of the strip-shaped member is risen up to that of the strip-shaped member in the conventional technology, any problem is not likely to occur, so that it is allowed to enhance, only by the amount corresponding to the above-mentioned lowered temperature, an operation speed of the heater, the pushing means, and the extruder, in other words, to rise the extrusion speed in the extruder. Thus, use of the present invention allows to easily increase extrusion amount of the strip-shaped member per a unit time from the extruder. The present invention is advantageous especially for the high-viscosity rubber or one which is difficult to be warmed evenly.

When the device is constructed as described in claim 3, a simple structure enables to inexpensively manufacture the device. Further, when the device is constructed as described in claim 4, rubber pressure between the pushing mechanism and the pusher is sufficiently high, and accordingly, the unvulcanized rubber is surely filled in the gear in the pusher, and thus, can be extruded in a fixed amount with high accuracy, and an amount of generated heat is considerably smaller than that in a screw-type one, so that the rubber can be extruded at a high speed. When constructed as described in claim 5, the device for extruding the strip-shaped member is small-sized and has a simple structure as well as can be inexpensively manufactured, and an arrangement of a pushing roller at one way thereof allows to further improve biting capability (pull-in capability), and thus, to stably push the unvulcanized rubber into the gear in the pusher, thereby improving the extrusion accuracy of the extruder.

Further, when the device is constructed as described in claim 6, an engagement gear pump is given a driving force due to an engagement of the engagement gear with the gear in the extruder, so that special driving means is not required for operating the engagement-type gear pump. When the device is constructed as described in claim 7, in a case where a type of the unvulcanized rubber to be extruded changes, the change can be easily handled by individually changing rotation speeds of the gear in the extruder, the feed rollers, and the pushing gear. Further, when constructed as described in claim 8, the device can be inexpensively manufactured and can save its installation space. Furthermore, when the device is constructed as described in claim 9, the temperature decrease of the strip-shaped body can be enlarged and the body can be prevented from fracturing between the heater and the pushing means. Besides, the present invention is preferable for the unvulcanized rubber as described in claim 10.

### BRIEF DESCRIPTION OF THE DRAWINGS

FIG. 1 is a partially-broken front view showing a first embodiment of the present invention.

FIG. 2 is an enlarged front cross-sectional view in the vicinity of an extruder, a pushing means.

FIG. 3 is a plan view of FIG. 2.

FIG. 4 is a cross-sectional view as viewed from a direction of Arrow I-I in FIG. 1.

FIG. 5 is an enlarged front cross-sectional view same as FIG. 2, showing a second embodiment of the present invention.

FIG. 6 is a cross-sectional view as viewed from a direction of Arrow II-II in FIG. 5.

FIG. 7 is a cross-sectional view as viewed from a direction of Arrow III-III in FIG. 5.

FIG. 8 is a plan view same as FIG. 3, showing a third embodiment of the present invention.

FIG. 9 is a schematic front view showing a forth embodiment of the present invention.

FIG. 10 is a schematic view showing a tire building apparatus using an extruding device for extruding a strip-shaped member, according to the present invention.

FIG. 11 is a schematic view showing a tire building apparatus using an extruding device for extruding a strip-shaped member, in a conventional technology.

### REFERENCE SYMBOLS

17 Heater
21 Extruder
22 Gear
31, 48, 50 Driving mechanism
35 Pushing means
37 Pushing gear pump
41 Feed rollers
56 Festoon
60 Pushing gear pump
61b, 62c Engagement gear
61c, 62a Pushing roller
64 Pushing means
169 Driving mechanism
K Unvulcanized rubber
Z Strip-shaped body
B Strip-shaped member

### BEST MODE FOR CARRYING OUT THE INVENTION

Hereinafter, a first embodiment of the present invention will be explained with reference to the drawings.

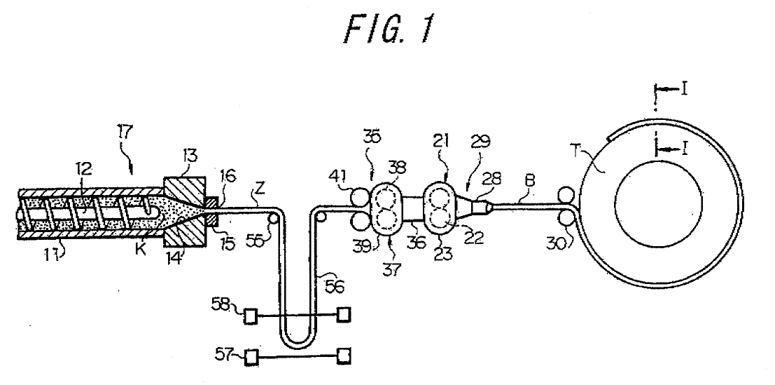

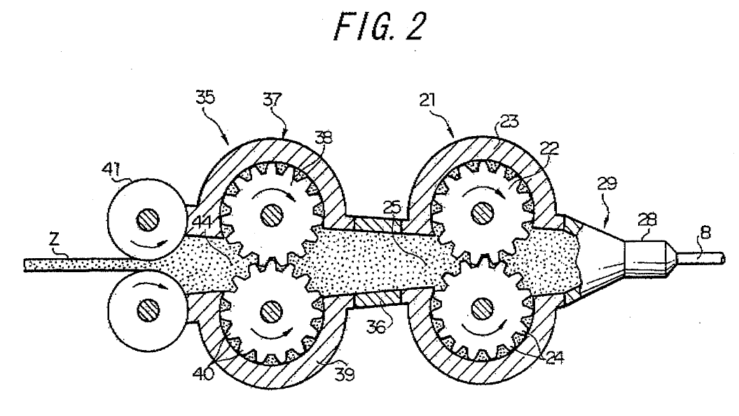

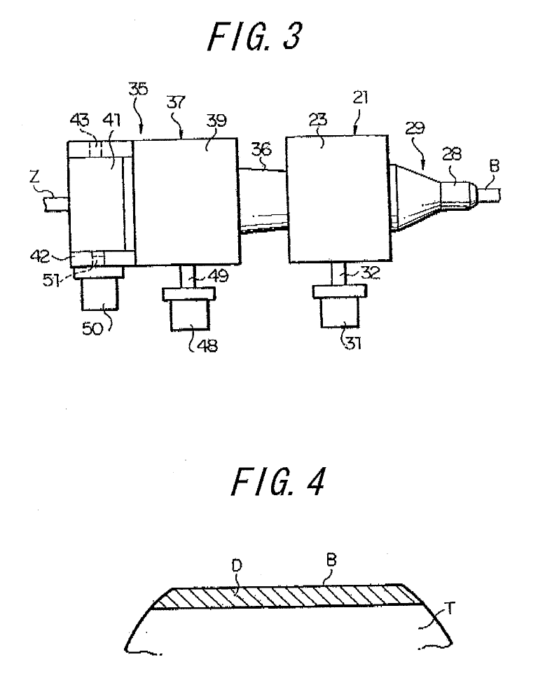

In FIGS. 1, 2 and 3, a numeral reference “11” denotes a generally cylindrically-shaped cylinder barrel that extends in a back-and-forth direction, and the cylinder barrel 11 accommodates therein a screw 12 that rotates in reaction to driving forth from a driving motor (not shown). There is provided a hopper (not shown) for guiding sheet-like or pellet-like unvulcanized rubber K into the cylinder barrel 11 at a rear end portion of the cylinder barrel 11. The unvulcanized rubber K having a normal temperature (cold state) as well as being fed in the cylinder barrel 11 through the hopper flows forwardly while at the same time being heated through rotation of the screw 12. At this time, the unvulcanized rubber K generates heat due to flow deformation thereof and friction resistance with the cylinder barrel 11 and the screw 12, and accordingly, its temperature rises.

At a front end (downstream end) of the cylinder barrel 11, there is fixed a head 13, there is formed a passage 14 in the head 13 through which the unvulcanized rubber K having flown in the cylinder barrel 11 passes. A numeral reference “15” denotes a die fixed at the front end of the head 13. At the die 15, there is formed an extrusion opening 16 through which the unvulcanized rubber K heated to a considerable extent or generally evenly due to the rotation of the screw 12 is extruded temporarily as strip-shaped body Z. Here, the above-mentioned cylinder barrel 11, the driving motor, the screw 12, the head 13, and the die 15, in their entirety, heat the unvulcanized rubber K and constitute a screw heater that extrudes the rubber K as the strip-shaped body Z.

A numeral reference “21” denotes a gear pump extruder for extruding a fixed amount, placed at a position in front of the heater 17 and spaced apart therefrom, and has a case 23 that accommodates therein a pair of gears 22. The respective gears 22 have, at its outer circumference, a number of external teeth 24 that slidingly contact with an internal surface of the case 23, and the teeth 24 of the pair of gears 22 engage with each other. At a rear end portion (upstream end portion) of the case 23, there is formed a supply opening 25, and thereinto, the unvulcanized rubber K turned from the strip-shaped body Z into an shapeless state is fed from an upstream side and pushed by a pushing means that will be explained later.

As a result, the unvulcanized rubber K fed into the supply opening 25 is charged between the external teeth 24 and the internal surface of the case 23 both being adjacent to each other, as well as transported forwardly (toward a downstream side) along an inner circumference of the case 23 due to the rotation of the gears 22. The gear pump extruder 21 has an extruding head 29 which is mounted to a front end of the case 23 and provided with a die 28 at a leading edge. The unvulcanized rubber K fed by the gears 22 is extruded from the die 28 as a strip-shaped member B having a predetermined cross-sectional shape, in this case, a rectangular cross-section. Then, the strip-shaped member B thus extruded is pushed by paste rollers 30 and spirally wound around an outer circumference of a rotating tire intermediate body T in the course of building, and for example, a tread D is formed as shown in FIG. 4.

In the gear pump extruder 21, the amount of the unvulcanized rubber K per a unit time relative to the die 28 is uniquely determined by a circumferential velocity of the external teeth 24, a spatial volume between the adjacent external teeth 24 and a pitch of the external teeth 24, so that when these are constant, the strip-shaped member B is extruded in a constant amount per a unit time from the gear pump extruder 21. A numeral reference “31” denotes a motor serving as a driving mechanism for applying driving force to the gear pump extruder 21. An output shaft of the motor 31 is connected to either one of the gears 22, in this case, to the lower gear 22; drives to rotate the lower gear 22; and dependently rotates the upper gear 22 at a constant velocity in a direction opposite to that of the lower gear 22. The motor serving as the driving mechanism may drive to rotate only the upper gear 22 or both of the upper and lower gears 22.

A numeral reference “35” denotes the pushing means placed at the upstream side of the gear pump extruder 21 and in close contact therewith. This pushing means 35 has a pushing gear pump 37 of which a front end (downstream end) is connected to a rear end (upstream end) of the gear pump extruder 21 via a supply pipe 36 through which the unvulcanized rubber K in a shapeless state passes. The pushing gear pump 37 has a case 39 that accommodates therein paired gears 38, and the outer circumference of the respective gears 38 is provided with a number of external teeth 40 that slidingly contact with an internal surface of the case 39 and engage with each other.

The pushing means 35 further has a pair of feed rollers 41 that rotate at the constant velocity in opposite directions. A rotation shaft 43 is rotatably supported by a pair of brackets 42 provided at a rear end of the case 39, and accordingly, the feed rollers 41 are arranged at a rear side of the gear pump 37, which places the pushing gear pump 37 between the gear pump extruder 21 and the feed rollers 41.

The rollers 41 and the heater 17 are spaced apart in the back-and-forth direction, so that when the feed rollers 41 rotate, the strip-shaped body Z in a heated state passes through the air between the heater 17, the pushing means 35 and the gear pump extruder 21, and then is pulled between the feed rollers 41 without any change (in a state extruded from the heater 17) to pass between the rollers 41, and thereafter, pushed into a supply opening 44 formed at a rear end portion of the case 39 and the gears 38 as the unvulcanized rubber K while at the same time being pressurized and turned into the shapeless state.

This prevents the air from mixing into the supply opening 44, and results in sufficient charging of the unvulcanized rubber K into the pushing gear pump 37. In a case where the pushing means 35 including such feed rollers 41 is not arranged at the upstream side of the gear pump extruder 21 and the strip-shaped body Z is directly fed to the gears 22 in the gear pump extruder 21, the body Z may insufficiently engage with the gears 22, and the extruder 21 may not be able to extrude the fixed amount, and accordingly, the air may mix thereinto.

In order for the feed rollers 41 to push the Unvulcanized rubber K into the pushing gear pump 37, given that the downstream side of the feed rollers 41 is not connected to the pushing gear pump 37 nor the gear pump extruder 21 and opens to the atmosphere, the amount of the fed rubber per a unit time from the feed rollers 41 needs to be greater than the amount of the fed and extruded rubber per a unit time from the pushing gear pump 37 and the gear pump extruder 21, respectively.

Thereafter, the shapeless unvulcanized rubber K fed to the supply opening 44 is charged between the adjacent external teeth 40 of the gears 38 and transported forwardly (toward the downstream side) along the inner circumference of the case 39 due to rotation of the gears 38, and then, is pushed into the supply opening 25 of the gear pump extruder 21 through the supply pipe 36 with only a fixed amount of the rubber being pressurized. In order for the feed rollers 37 to push the Unvulcanized rubber K into the gear pump extruder 21, given that the downstream side of the pushing gear pump 37 is not connected to the gear pump extruder 21 and opens to the atmosphere, the amount of fed rubber per a unit time from the pushing gear pump 37 needs to be greater than the amount of extruded rubber per a unit time from the gear pump extruder 21.

When the pushing means 35, which pulls the strip-shaped body Z extruded from the heater 17 and having passed through the air and pushes the body Z into the gear pump extruder 21 as the shapeless unvulcanized rubber K, has the feed rollers 41 as well as the pushing gear pump 37, which is placed between the gear pump extruder 21 and the pair of feed rollers 41 and which pushes the unvulcanized rubber K having passed between the feed rollers 41 into the gear pump extruder 21, rubber pressure between the pushing gear pump 37 and the gear pump extruder 21 is high enough to ensure the unvulcanized rubber K to be charged to the gears 22 in the gear pump extruder 21, thereby enabling the extruder 21 to extrude the rubber K by the fixed amount. Further, since the amount of heat generated is considerably lower than that in a screw pushing means, the extrusion can be performed at a higher speed.

In addition, the unvulcanized rubber K is extruded under the atmosphere, which is lower than that in a conventional technology, to form the strip-shaped body Z as described above, so that the flow as described above arisen from a back flow, retention, or pressure-reducing is not likely to occur, and the temperature of the strip-shaped body Z extruded from the heater 17 considerably falls, for example, by approximately 20 deg. C. Thereafter, the strip-shaped body Z (unvulcanized rubber K) sequentially passes between the feed rollers 41 and through the pushing gear pump 37. At this time, the unvulcanized rubber K has been evenly heated, which leads to high fluidity (low viscosity), and furthermore, the back flow and the like is not likely to occur in the pushing gear pump 37, so that the temperature hardly rises. Such results in lowering the temperature of the strip-shaped member B (the unvulcanized rubber K) at the time of being extruded from the gear pump extruder 21 compared with that in the conventional technology significantly, for example, by approximately 10 to 20 deg. C.

Speeding up the extrusion speed in the gear pump extruder 21 leads to an increase in the flow, the friction resistance and the like mostly in the heater 17, thereby raising the temperature of the strip-shaped member B. However, even when the temperature of the strip-shaped member B is raised up to that of the strip-shaped member in the conventional technology, any problem is not likely to occur, so that it is allowed to speed up an operation speed of the heater 17, the pushing means 35, and the gear pump extruder 21 only by a degree corresponding to the above-mentioned lowered temperature, in other words, to raise the extrusion speed at the time of extrusion. Thus, employing the present embodiment allows the amount of the strip-shaped member B extruded from the gear pump extruder 21 per a unit time to be easily raised up to approximately 1.3 to 1.8 times compared with that in the conventional technology, when other conditions are same.

The present embodiment is advantageous especially for high-exothermicity and high-viscosity rubber such as natural rubber compounded with minute particles of carbon black, or rubber which is difficult to be evenly heated such as natural rubber having smaller amount of filler (filling agent such as carbon) and lower thermal conductivity. When the unvulcanized rubber K to be threw into the heater 17 is the high-viscosity rubber, rubber having Mooney viscosity ML1+4 (100 deg. C.) within a range of 40 to 200 can be preferably used. It is noted that the above-mentioned Mooney viscosity ML1+4 is rubber viscosity measured in accordance with JIS (Japanese Industrial Standards) K6300.

A numeral reference “48” denotes the motor serving as the driving mechanism for applying the driving force to the gear pump extruder 37. An output shaft 49 of the motor 48 is connected to either one of the gears 38, in this case, to the lower gear 38; drives to rotate the lower gear 38; and dependently rotates the upper gear 38 at the constant velocity in the direction opposite to the rotational direction of the lower gear 38. The motor serving as the driving mechanism may drive to rotate only the upper gear 38 or both of the upper and lower gears 38. Controlling the rotation velocity of the output shaft 49 of such motor 48 allows the pushing gear pump 37 to easily push the unvulcanized rubber K into the gear pump extruder 21.

To the rotation shaft 43 of the respective feed rollers 41, there is connected an output shaft 51 of a motor 51 serving as the driving mechanism. As a result, the pair of feed rollers 41 rotate in the mutually opposite directions at the constant velocity due to the driving force applied by the motor 50. Controlling the rotation velocity of the output shaft 51 of such motor 50 allows the feed rollers 41 to easily push the unvulcanized rubber K into the gear pump extruder 37.

In this way, given that the driving force is applied to the gear pump extruder 21, the pushing gear pump 37, and the feed rollers 41 from the respectively corresponding separate motors 31, 48, and 50, whereby these are driven, in a case where a type of the unvulcanized rubber K to be extruded changes, the change can be easily handled by individually adjusting the rotation speed of the gear pump extruder 21, the pushing gear pump 37, and the feed rollers 41.

A numeral reference “55” denotes a pair of parallel rollers provided between the heater 17 and the pushing means 35, more specifically, the feed rollers 41, and these rollers 55 are rotatably supported by an not-shown frame. When the strip-shaped body Z extruded from the heater 17 is guided to the rollers 55, the body Z is stretched between the rollers 55 to form a festoon 56 having a predetermined length.

A numeral reference “57” denotes lower-limit detecting sensors placed beneath the rollers 55. When a lower end of the festoon 56 descends to a descent limit, the lower-limit detecting sensors 57 detect the lower end and lower the extrusion speed of the strip-shaped Z extruded by the heater 17 or stops the extrusion. A numeral reference “58” denotes upper-limit detecting sensors placed above the lower-limit detecting rollers 57. When the lower end of the festoon 56 ascends to an ascent limit, the upper-limit detecting sensors 58 detect the lower end and raise the extrusion speed of the strip-shaped body Z extruded by the heater 17. These constantly maintain the length of the festoon 56 within a predetermined range. A dancer roll may be used in order to control the festoon 56.

The festoon 56 may be maintained to the predetermined length by detecting the rotation speed of the respective feed rollers 41 and the gears 38 while at the same time, on the basis of the detected result, changing the extrusion speed of the strip-shaped body Z from the heater 17. When the festoon 56 having the predetermined length is provided to the strip-shaped body Z stretched between the heater 17 and the pushing means 35 as described above, the strip-shaped body Z can experience a huge drop in its temperature, and the strip-shaped body Z can be effectively prevented from fracturing between the heater 17 and the pushing means 35.

Next, an operation of the first embodiment will be explained.

When an extruding device as mentioned above extrudes the unvulcanized rubber K as the strip-shaped member B, the unvulcanized rubber K having the normal temperature is firstly threw into the heater 17 in which the screw 12 is rotating, and the screw 12 heats the unvulcanized rubber K, and then, the rubber K is flown forwardly (toward the leading edge) inside the cylinder barrel 11 while at the same time decreasing its apparent viscosity. Thereafter, the extruding device extrudes from an extrusion opening 16 the unvulcanized rubber K heated to a certain extent or generally evenly due to the rotation of the screw 12 temporarily as the strip-shaped body Z.

Next, the pair of feed rollers 41 (pushing means 35) pulls therein the strip-shaped body Z extruded from the heater 17 and having passed through the air without any change. At this time, the unvulcanized rubber K is extruded under the atmospheric pressure lower than that in the conventional technology to form the strip-shaped body, so that the flow as found in the conventional technology, arisen from the back flow, the retention, or the pressure-reducing, is not likely to occur, and there is considerably lowered the temperature of the strip-shaped body Z extruded from the heater 17. The strip-shaped body Z pulled between the feed rollers 41 is pushed in the gear pump extruder 37 as the shapeless unvulcanized rubber K, after passing between the feed rollers 41.

Next, after being pushed in the gear pump extruder 21 only by the fixed amount via the supply pipe 36 due to the rotation of the gears 38, the unvulcanized rubber K is extruded from the die 28 due to the rotation of the gears 22 in the extruder 21, and accordingly, the strip-shaped member B is formed. At this time, the unvulcanized rubber K generates the heat, and accordingly, its temperature rises. However, the temperature rise is slight, so that the strip-shaped member B (unvulcanized rubber K) in the die 28 of the gear pump extruder 21 keeps its temperature considerably lowered compared with that in the conventional technology.

In this state, when the operation speeds of the heater 17, the pushing means 35, and the gear pump extruder 21 are raised, in other words, the extrusion speed at the time of extrusion is raised to raise the temperature of the strip-shaped member B up to that of a strip-shaped member in the conventional technology, any problem is not likely to occur. As a result, the present embodiment enables to easily raise the extrusion speed of the strip-shaped member B from the gear pump extruder 21.

Thereafter, the strip-shaped member B is spirally wound around the outer circumference of the tire intermediary T to form the tread D. At this time, the gear pump extruder 21 continuously extrudes the unvulcanized rubber having the predetermined amount with high accuracy, so that the cross-sectional shape of the strip-shaped member B is stabilized with high accuracy, and this makes it possible to manufacture a pneumatic tire having high roundness, and further, smaller fluctuation in mass.

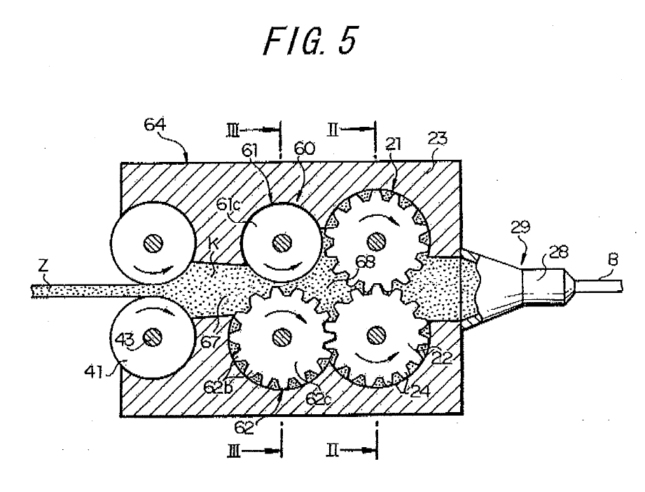

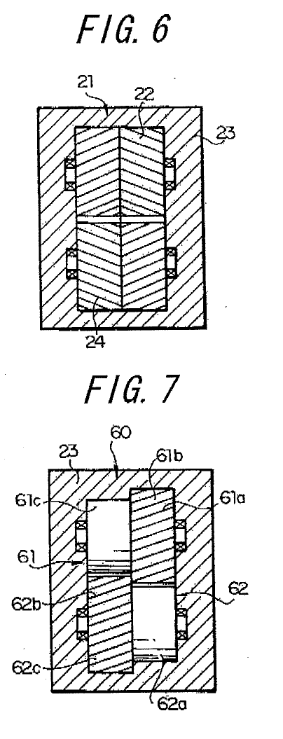

Each of FIGS. 5, 6, and 7 is a view showing a second embodiment of the present invention. The present embodiment omits the supply pipe 36 as well as the pushing gear pump 37 connected to the gear pump extruder 21 via the supply pipe 36, and places an engagement-type pushing gear pump 60 in close contact with a rear side (at the upstream side) of the gear pump extruder 21. This engagement-type gear pump 60 is accommodated in the case 23, and has a pair of pushers 61, 62 that rotates at the constant velocity as well as in the mutually opposite direction. At one side in an axial direction of the upper pusher 61, there is provided an engagement gear 61b on which a number of external teeth 61a in slidingly contact with the internal surface of the case 23 are formed, the external teeth 61a of the engagement gear 61b being engaged with the external teeth 24 of the one of the gears 22 (in this case, the upper one) in the gear pump extruder 21.

Meanwhile, at one side in the axial direction of the lower pusher 62, there is provided a pushing roller 62a of which the outer circumference is constructed of a smooth circumferential surface and which has a diameter smaller than that of a root circle of the engagement gear 61b. The pushing roller 62a is positioned slightly apart from both of the engagement gear 61b and the other (in this case, the lower) gear 22. As a result, slight clearances are formed between the pushing roller 62a and the engagement gear 61b, as well as between the roller 62a and the other (in this case, the lower) gear 22, through which the unvulcanized rubber K can pass.

Additionally, at the other side of the lower pusher 62 in the axial direction, there is provided an engagement gear 62c on which a number of external teeth 62b in slidingly contact with the internal surface of the case 23 are formed, the external teeth 62a of the engagement gear 62c being engaged with the external teeth 24 of the one of the gears 22 (in this case, the lower gear) in the gear pump extruder 21. Meanwhile, at the other side in the axial direction of the upper pusher 61, there is provided a pushing roller 61c of which the outer circumference is constructed of a smooth circumferential surface and which has the diameter smaller than that of the root circle of the engagement gear 62c. The pushing roller 61c is positioned slightly apart from both of the engagement gear 62c and the other (in this case, the upper) gear 22. As a result, slight clearances are formed between the pushing roller 61c and the engagement gear 62c, as well as between the roller 61c and the other (in this case, the upper) gear 22, through which the unvulcanized rubber K can pass.

When the engagement gears 61b, 62c are driven to rotate at the constant velocity in the mutually opposite directions by applying the driving force from the gears 22 engaging with the gears 61b, 62c in the gear pump extruder 21, thereby operating the engagement gear pump 60, the special driving means for operating the gear pump 60 is not required. Note that in the present embodiment, the gears in which tooth traces thereof incline with respect to the axial direction, namely, helical gear are used as the gears 22 and the engagement gears 61b, 62c, however, spur gear in which the tooth traces thereof are parallel to the axial direction may also be used.

The feed rollers 41 are rotatably accommodated to rearward of the pushing gear pump 60 and at the rear end portion of the case 23. In this case, there is integrally formed the pushing means 64 including the gear pump extruder 21, the pushing gear pump 60 (engagement-type gear pump), and the feed rollers 41 by accommodating in the case 23 the gears 22, the engagement gears 61b, 62c, and the feed rollers 41, however, the gear pump extruder 21, the pushing gear pump 60, and the feed rollers 41 may be separately provided by accommodating the gears 22 and the engagement-type gears 61b, 61c in the case 23 while at the same time having the bracket provided at the rear end of the case 23 or the case support the feed rollers 41 so as to engage the gears 22 with the engagement gears 61b, 62c, respectively.

When the feed rollers 41 rotate, the strip-shaped body Z kept heated is pulled between the feed rollers 41 without any change (remaining with the rollers 41 extruded from the heater 17) to pass between the rollers 41, and thereafter, pushed into a supply opening 67 as well as the engagement gears 61b, 61c formed between the feed rollers 41 and the pushing gear pump 60 at the upstream side of the pushing gear pump 60 as the unvulcanized rubber K while at the same time being pressurized and turned into the shapeless state.

Afterward, the shapeless unvulcanized rubber K supplied to the supply opening 67 is pulled in due to opposite rotations of the pushers 61, 62, and passes between the engagement gear 61b and the pushing roller 62a as well as between the engagement gear 62c and the pushing roller 61c, and thereafter, pushed into the supply opening 68 formed between the gear pump extruder 21 and the pushing gear pump 60 at the upstream side of the extruder 21 while at the same time being pressurized. At this time, the external teeth 61b, 62b are formed on outer circumferences of the engagement gears 61b, 62c, respectively, so that the unvulcanized rubber K is surely pulled and pushed therein. Sequentially, the unvulcanized rubber K passes between the pushing rollers 61c, 62a and the gears 22, and thereafter, is charged between the adjacent external teeth 24 and the internal surface of the case 23, and forwardly transported, in the same manner as the above-mentioned.

As mentioned above, when the pushing gear pump 60 rotates at the constant velocity in the opposite directions and is constructed of the engagement-type gear pump provided with the engagement gears 61b, 61c and the pushing rollers 61c, 62a, in addition to the effect which the pushing gear pump 37 exerts as explained in the first embodiment, connection by means of external gears, a chain and the like is not required, and a structure of the gear pump 60 is small-sized and simple, and accordingly, the gear pump 60 can be inexpensively manufactured, and at the same time, an arrangement of the rollers 61c, 62a at one way of the gear pump 60 allows to further improve biting capability (pull-in capability) and to stably push the unvulcanized rubber K into the gears 22 in the gear pump extruder 21, and this makes it possible to improve extrusion accuracy by means of the extruder 21. Depending on circumstances, the feed rollers 41 can be omitted. Thus, the pushing gear pump 60 preferably employs the engagement-type gear pump like the present second embodiment rather than the pushing gear pump 37 explained in the first embodiment. It is noted that other construction and operations are same as those in the first embodiment.

FIG. 8 is a view showing a third embodiment of the present invention. In the present embodiment, the motors 31, 48, and 50 in the first embodiment are omitted, and an external gear 163 is fixed to the leading edge of a rotation shaft 162 of the gears 22. Further, an external gear 167 engaging with an external gear 166 which is fixed to the leading edge of a rotation shaft 165 of the feed rollers 41 is fixed to the leading edge of a rotation shaft 164 of the gears 38. A numeral reference “168” denotes the external gear that is placed between and engages with both of the external gears 163, 167, and an output shaft 170 of a motor 169 serving as the driving mechanism is fixed to the external gear 168.

When the motor 39 operates to drive to rotate its output shaft 170, the external gears 163, 166, and 167 rotate while dependently following the external gear 168. In this way, when the gear pump extruder 21, the feed rollers 41, and the pushing gear pump 37 are driven by distributedly imparting thereto the driving force from the one motor 169, the driving mechanism can be inexpensively manufactured and its installation space can be saved. In the present embodiment, the unvulcanized rubber K is pulled in the gear pump 37 and the gear pump extruder 21 by adjusting a radius and the like of the respective external gears 163, 166, 167, and 168. It is noted that other construction and operations are same as those in the first embodiment.

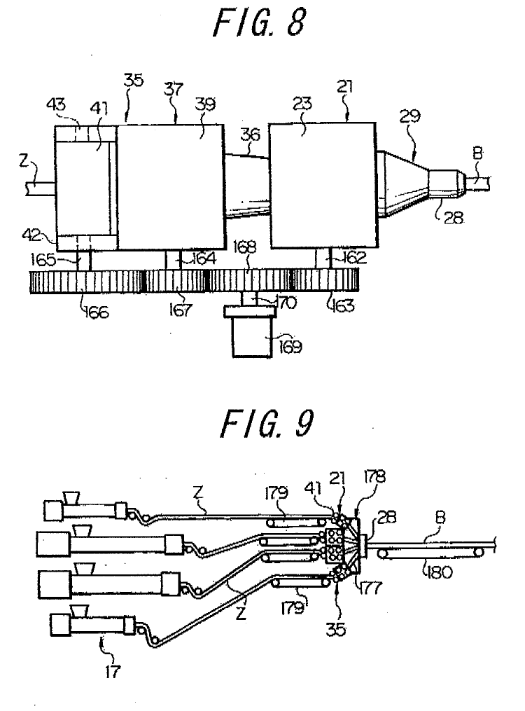

FIG. 9 is a view showing a forth embodiment of the present invention. In the present embodiment, there are arranged the plurality of, in this case, four heaters 17 in rows, and at positions spaced apart from the heaters 17, there are placed the pushing means 35 and the gear pump extruders 21 both having the same number as the heaters 17, in this case, four. At the front end of the case 23 of the gear pump extruders 21, there is mounted a single pushing head 178 in which a plurality of, in this case, four extrusion passages 177 extending generally in the back-and-forth direction are formed.

After the unvulcanized rubber K is extruded by the respective heaters 17 as the strip-shaped body Z having different kinds, when fed into the pushing passages 177 in the gear pump extruders 21 through conveyors 179 and the pushing means 35, the rubber K is extruded through the die 28, thereby easily forming a member B that consists of a plurality of, in this case, four layers having a predetermined contour, in which each of the layers is made up of the different-typed rubber, and exerts a strip shape in its entirety. Afterward, the formed member B is transported to a next step by a conveyor 180. Then, construction as mentioned-above allows the device for extruding the member B having the plurality of layers to be compact. It is noted that other construction and operations are same as those in the first embodiment.

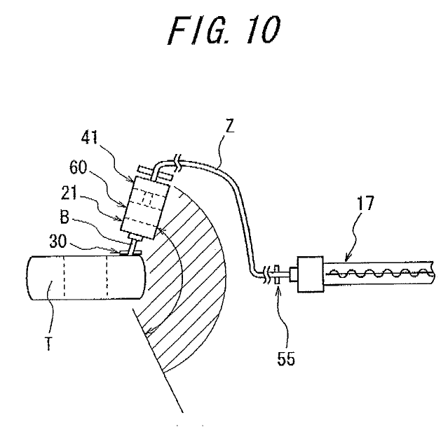

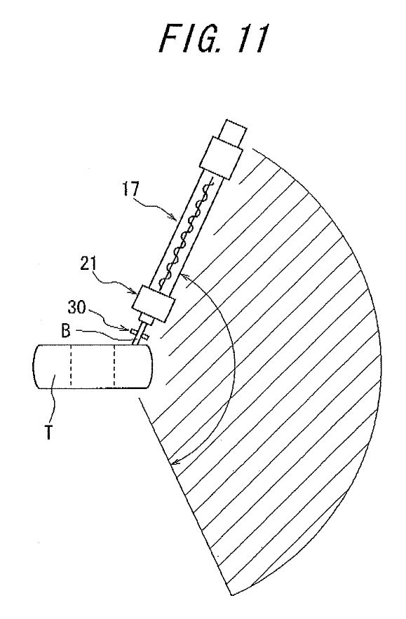

FIG. 10 is a schematic view showing a tire building apparatus using the extruding device for extruding the strip-shaped member according to the present invention. FIG. 11 is a schematic view showing a tire building apparatus using an extruding device for extruding strip-shaped member of a conventional technology. As illustrated, in the tire building apparatus using the extruding device for extruding the strip-shaped member of the present invention, the strip-shaped member B can be attached onto the tire intermediate body T while at the same time fixing the heater 17 having comparatively larger weight and moving only the extruder 21. Meanwhile, in the tire building apparatus using the extruding device for extruding the strip-shaped member of the conventional technology, the heater 17 is directly connected to the extruder 21, so that when attaching the strip-shaped member B onto the tire intermediary T, both of the heater 17 and the extruder 21 are required to pivot around the tire intermediate body T. Therefore, the tire building apparatus using the extruding device for extruding the strip-shaped member of the conventional technology requires more space for the pivot of the heater 17 and the extruder 21, and has larger weight, so that large pivoting power is required, and it is also difficult to secure lamination accuracy of the strip-shaped member B onto the intermediary T. To the contrary, in the tire building apparatus using the extruding device for extruding the strip-shaped member of the present technology, only the extruder 21 needs to pivot, so that those problems are not like to occur. It is noted that FIG. 10 merely illustrates one example of the tire building apparatus to which the extruding device for extruding the strip-shaped member according to the present invention is applicable, and therefore, the extruding device for extruding the strip-shaped member according to the present invention shall not be limited to the illustrated tire building apparatus and can be incorporated in various apparatuses.

In the above-mentioned embodiments, the pushing means 35 includes the gear pump 37 and the feed rollers 41, however, in the present invention, the pushing gear pump 37 may be omitted and the pushing means 35 may be consisted only of the feed rollers 41, and accordingly, the unvulcanized rubber K may be directly pushed into the gear pump extruder 21 without passing through the pushing gear pump 37. In this case, the pushing means 35 can also have a simple structure and be inexpensively manufactured.

In this regard, when the pushing means 35 is consisted only of the feed rollers 41 in this way, skidding and the like may occur between the strip-shaped body Z and the feed rollers 41, and the unvulcanized rubber K may be insufficiently charged in the gear pump extruder 21, and accordingly, the extrusion accuracy of the strip-shaped member B may be lowered. In this state, in order for the feed rollers 41 to push the Unvulcanized rubber K into the gear pump extruder 21, given that the downstream side of the pushing gear pump 41 is not connected to the gear pump extruder 21 and open to the atmosphere, the amount of rubber fed from the feed rollers 41 per a unit time needs to be greater than the amount of rubber extruded per a unit time from the gear pump extruder 21.

In the above-mentioned embodiments, by controlling the rotation speed of the respective motors 31, 48, and 50, or adjusting the radius of the respective external gears 163, 166, 167, and 168, the unvulcanized rubber K is pushed into the pushing gear pump and the gear pump extruder 21, however, the rubber K may be pushed by adjusting a radius of pitch circle, a module of the gears, or the radius of the feed roller in the pushing gear pump and the gear pump extruder.

Further, the above-mentioned embodiments employ the screw heater as the heater 17, however, in the present invention, a gear pump heater or a heating roller heater may be employed. Additionally, in the above-mentioned embodiments, there is used a pair of gears 38 that engage with each other as a portion of the pushing gear pump 37, however, in the present invention, there may be provided the two or more pairs of gears, in short, it is possible to employ any gear capable of pushing the unvulcanized rubber into the extruder (except the screw-type one).

In addition, in the above-mentioned embodiment, the tread D is constructed by spirally winding the strip-shaped member B around the tire intermediate body T, or, by merely winding the member B one round, however, in the present invention, a side tread may be constructed by winding the member B around the tire intermediate body, or, after being rewound in a roll-shape once, the member B may be wound off when needed, and be fed to the tire intermediate body. Further, in the present invention, the strip-shaped body Z may be hung around a cooling roll between the heater and the pushing means, and accordingly, be forcibly cooled. Furthermore, in the above-mentioned embodiments, extruded from the gear pump extruder 21 is the strip-shaped member B having a narrow width that forms the tread or the side tread by being spirally and windingly wound around the tire intermediate body T, however, in the present invention, the extruder may extrude the member having a wide width (e.g., a generally same length as that of a tread width) extruded in the shape of the tread and the like. In this case, the tread and the like can be formed only by performing the one-round attaching of the member around the tire intermediate body.

### EXAMPLE

Next, a test example will be explained. In this test, there were prepared Conventional device in which the gear pump extruder was directly connected to the leading edge of the screw heater; Embodiment device 1 in which the gear pump extruder was placed at a position spaced apart from the screw type and the pushing means including the feed rollers and the pushing gear pump were placed in the vicinity of the upstream side of the extruder, as illustrated in FIG. 5; Embodiment device 2 in which the pushing gear pump in the first embodiment was omitted and the pushing means was composed of the feed rollers alone; and Comparative device in which the feed rollers and the pushing gear pump in the first embodiment were omitted while, in place thereof, the screw pushing means was placed.

Here, the screw heater in Conventional device and the screw pushing means in Comparative device respectively had an inner diameter of 120 mm; a value L/D in which each screw length L thereof divided by an outer diameter D was 4.8; each inner diameter of Embodiment devices 1 and 2 as well as Comparative device was 90 mm; and L/D of the respective screws was 14. Further, in each of Conventional, Embodiment, and Comparative devices, an aperture of the die through which the strip-shaped member was extruded had the width of 30 mm and a height of 2.5 mm.

Next, the unvulcanized rubber made up of the natural rubber as well as having the value of ML1+4 (100 deg. C.) was threw into the heater in each of Conventional, Embodiment, and Comparative devices with the rubber at the normal temperature (in the cold state). Here, in each of Embodiment devices 1 and 2 as well as Comparative device, the heated (hot) unvulcanized rubber was extruded from the extruder in a form of the strip-shaped body, and thereafter, the body was fed to the pushing means. Afterward, the strip-shaped body was extruded from each of Embodiment and Comparative devices, and there were measured the amount of the extruded strip-shaped member per a unit time (cm³/min), the extrusion accuracy (%), an extrusion temperature (deg. C.), a rubber property, and whether or not premature crosslinking occurred.

Table 1 shows the results. In this Table 1, the extrusion accuracy is shown using a value generally called as a variant coefficient Cv, which is obtained by dividing the variation in the extrusion amount by the mean extrusion amount and then centupling the product, as well as in a percentage, and the rubber property is obtained by performing a five-grade evaluation relative to a heat degree on the basis of a border crack, a perforation and the like, and the larger its value is, the more sufficiently the rubber is heated.

TABLE 1

| | Conventional | Embodiment | Embodiment | Conventional |
|---|---|---|---|---|
| | device | device 1 | device 2 | device |
| Extrusion | 3,500 | 6,000 | 6,300 | 4,500 |
| amount | | | | |
| Extrusion | 0.5 | 0.4 | 1.0 | 0.3 |
| accuracy | | | | |
| Extrusion | 115 | 114 | 113 | 115 |
| temperature | | | | |
| Rubber | 3 | 5 | 4 | 5 |
| property | | | | |
| Presence or | Presence | Absence | Absence | Absence |
| absence of | | | | |
| premature | | | | |
| crosslinking | | | | |

As apparent from Table 1, Conventional device has the smaller extrusion amount, the lower heat degree, and the worse rubber property due to temperature restriction, however, each of Embodiment devices has more considerably improved extrusion amount and the rubber property (heat degree) compared with those in Conventional device. Embodiment device 2 has the considerably large extrusion accuracy of 1.0%, and this is considered to be attributable to the cause that the unvulcanized rubber has been uncertainly charged in the gear pump extruder that employs only the feed rollers as the pushing means.

### INDUSTRIAL APPLICABILITY

The present invention can be applied to an industrial field to which an extruding device for extruding strip-shaped member, having a gear pump extruder, pertains.

1. A method for extruding a strip-shaped member, comprising the steps of:
heating unvulcanized rubber using a heater and extruding the rubber as a strip-shaped body;
pulling in a pushing means the strip-shaped body extruded from the heater as well as having passed through the air without any change, and pushing as well as feeding the body in a gear pump extruder as the shapeless unvulcanized rubber; and
extruding the fed unvulcanized rubber using the extruder to form a strip-shaped member.

2. A device for extruding a strip-shaped member, comprising:
a heater for heating unvulcanized rubber and extruding the rubber as a strip-shaped body;
a gear pump extruder placed at a position spaced apart from the heater, and for extruding the fed unvulcanized rubber to form a strip-shaped member; and
a pushing means placed adjacently at an upstream side of the extruder and pulling the strip-shaped body extruded from the extruder as well as having passed through the air into the pushing means without any change to push the body in the extruder as the shapeless unvulcanized rubber.

3. The device for extruding the strip-shaped member according to claim 2, wherein the pushing means comprises a pair of feed rollers which rotates at a constant velocity in mutually opposite directions and allows the strip-shaped body to pass therebetween.

4. The device for extruding the strip-shaped member according to claim 3, wherein the pushing means is placed between the extruder and the pair of feed rollers, and further comprises a pushing gear pump for pushing the unvulcanized rubber having passed between the feed rollers into the extruder.

5. The device for extruding the strip-shaped member according to claim 4, wherein the pushing gear pump is an engagement-type gear pump comprising an engagement gear for engaging with one of the gears in the extruder; and a pushing roller placed apart from the other gear in the extruder as well as from both of the engagement gears, the roller rotating at a constant velocity in a direction opposite to that of the engagement gears and having an outer circumference constructed of a smooth circumferential surface.

6. The device for extruding the strip-shaped member according to claim 5, wherein the engagement gear is driven to rotate by applying driving force from the gear in the extruder.

7. The device for extruding the strip-shaped member according to claim 4, wherein the extruder, the feed rollers and the pushing gear pump are driven by applying the driving force from respective separate driving mechanisms thereto.

8. The device for extruding the strip-shaped member according to claim 4, wherein the extruder, the feed rollers and the pushing gear pump are driven by distributed imparting the driving force from one driving mechanism thereto.

9. The device for extruding the strip-shaped member according to claim 2, wherein a festoon is formed on the strip-shaped body stretched between the heater and the pushing means.

10. The device for extruding the strip-shaped member according to claim 2, wherein the unvulcanized rubber to be threw in the heater is rubber having a value of ML1+4 (100 deg. C.) within a range of 40 to 200.
